(19) United States
(12) Patent Application Publication
(10) Pub. No.: US 2014/0270258 A1
(43) Pub. Date: Sep. 18, 2014

(54) APPARATUS AND METHOD FOR EXECUTING OBJECT USING VOICE COMMAND

(71) Applicant: Pantech Co., Ltd., Seoul (KR)

(72) Inventor: Sung Sik WANG, Anyang-si (KR)

(73) Assignee: Pantech Co., Ltd., Seoul (KR)

(21) Appl. No.: 13/973,580

(22) Filed: Aug. 22, 2013

(30) Foreign Application Priority Data
Mar. 15, 2013 (KR) 10-2013-0028069

(51) Int. Cl. G10L 21/00

(52) U.S. Cl. CPC G10L 21/00
USPC 381/110

(57) ABSTRACT

A terminal and a method are disclosed. The method utilizes a processor for executing an object using a voice command, and the method includes: searching for an executable object in an application; and associating a text command information with the executable object. The method can further include: receiving a voice; recognizing the voice to obtain a voice command; and executing the executable object, when the voice command is similar to the text command information associated with the executable object.

### CROSS-REFERENCE TO RELATED APPLICATION

This application claims priority from and the benefit under 35 U.S.C. §119(a) of Korean Patent Application No. 10-2013-0028069, filed on Mar. 15, 2013, the entire disclosure of which is incorporated herein by reference for all purposes as if fully set forth herein.

### BACKGROUND

1. Field

The following description relates to a voice recognition technique, and more particularly, an apparatus and method for executing an object using a voice command.

2. Discussion of the Background

Voice recognition is a technology that analyzes a voice wave form to identify a is word or word sequence, and thus derive a meaning of the word or word sequence. Recently, voice recognition is employed in various applications and devices.

When applied in an application, voice recognition may be used by executing a voice recognition engine in the form of Software Development Kit (SDK) inside of the application or by receiving an audio-to-text data from an additional voice recognition application. A user is allowed to do a desirable operation by executing the corresponding application through a touch or another user input, rather than a voice command. In addition, voice recognition cannot be applied in an application that is not designed to support voice recognition.

### SUMMARY

Exemplary embodiments of the present invention provide voice reorganization to execute an object.

Additional features of the invention will be set forth in the description that follows, and in part will be apparent from the description, or may be learned by practice of the invention.

An exemplary embodiment of the present invention discloses a method, utilizing a processor, for executing an object using a voice command, the method including: searching for an executable object in an application; and associating a text command information with the executable object.

An exemplary embodiment of the present invention discloses a terminal for executing an object using a voice command, the terminal including: a searching unit configured to search for an executable object in an application; and a text information obtaining unit configured to associate a text command information with the executable object.

It is to be understood that both the foregoing general description and the following detailed description are exemplary and explanatory and are intended to provide further explanation of the invention as claimed.

### BRIEF DESCRIPTION OF THE DRAWINGS

The above and other objects, features and advantages of the present disclosure will become apparent from the following description of certain exemplary embodiments given in conjunction with the accompanying drawings. The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a configuration of an apparatus for executing an object using a voice command according to exemplary embodiments of the present invention.

FIG. 2 is a diagram illustrating an example of a screen on which objects are displayed.

FIG. 3 is a diagram illustrating an example of a User Interface (UI) generated by a UI generating unit illustrated in FIG. 1.

FIG. 4 is a flow chart illustrating a method for executing an object using a voice command according to exemplary embodiments of the present invention.

FIG. 5 is a diagram illustrating a configuration of an apparatus for executing an object using a voice command according to exemplary embodiments of the present invention.

FIG. 6 is a diagram illustrating an example of a UI generated by a UI generating unit illustrated in FIG. 5.

FIG. 7 is a flow chart illustrating a method for executing an object using a voice command according to exemplary embodiments of the present invention.

FIG. 8 is a diagram illustrating a configuration of an apparatus for executing an object using a voice command according to exemplary embodiments of the present invention.

FIG. 9 is a diagram illustrating an example of a UI generated by a UI generating unit illustrated in FIG. 8.

FIG. 10 is a flow chart illustrating a method for executing an object using a voice command according to exemplary embodiments of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Descriptions of well-known functions and constructions may be omitted for is increased clarity and conciseness.

It will be understood that when an element is referred to as being “connected to” another element, it can be directly connected to the other element, or intervening elements may be present. Further, it will be understood that when a feature is described as being “predetermined”, that feature may be determined or set by a manufacturer, programmer, carrier, or a user.

In exemplary embodiments of the present invention, an object is a basic element composing an application, and is displayed on a screen. The object performs an operation in accordance with a user input. On ANDROID platform, for example, the object may indicate an ‘activity.’

FIG. 1 is a diagram illustrating a configuration of an apparatus for executing an object using a voice command according to exemplary embodiments of the present invention, and FIG. 2 is a diagram illustrating an example of a screen on which objects are displayed.

Referring to FIG. 1 and FIG. 2, an apparatus 100 for executing an object using a voice command may include a voice receiving unit 110, a voice recognizing unit 120, an object searching unit 130 and an object driving unit 140.

The voice receiving unit 110 may receive a voice from a user.

The voice recognizing unit 120 obtains voice command information by recognizing and analyzing the voice received by the voice receiving unit 110. The voice command information is information about the voice of the user, which is recognized by the apparatus 100 through voice recognition. For example, if a voice saying ‘confirm’ is received from the user, voice command information which is obtained by recognizing the user's voice includes ‘confirm’. The voice command information may include text data.

The voice recognizing unit 120 may utilize a Speech To Text (STT) technique when obtaining voice command information by analyzing the user's voice. The above is merely an example, and aspects of the present invention are not limited thereto. Thus, various techniques may be utilized when obtaining voice command information by analyzing a user's voice.

The object searching unit 130 may search for an executable object. The object searching unit 130 may search for an executable object in an application or program being executed in a foreground. In some embodiments, the object searching unit 130 may search for an executable object in an application or program being executed in a background, in accordance to setting conditions, for example, set by a user. The apparatus 100 may be used in an application being executed in either a foreground or a background, according to system performance or purpose of use.

Referring to FIG. 2, when an alarm application providing, for example, an alarm function, a world time function, a stopwatch function and a timer function is being executed in a foreground, the object searching unit 130 may search for an object 1 210 for checking a world time, an object 2 220 for executing the stop watch function, an object 3 230 for executing the timer function, an object 4 240 for setting an alarm, and an object 5 250 for executing the alarm function.

Based on the voice command information obtained by the voice recognizing unit 120, the object driving unit 140 may execute one of the objects found by the object searching unit 130. In some embodiments, the object driving unit 140 may include a text information obtaining unit 141, a comparing unit 142 and an object executing unit 143.

The text information obtaining unit 141 may obtain text information or text is command information from each of the objects found by the object searching unit 130. For example, as the object 1 210 in FIG. 2 is displayed to be ‘world time’, text information regarding or associated with the object 1 210 is ‘world time.’ Similarly, text information regarding or associated with the object 2 220 is ‘stopwatch’ because the object 2 220 is displayed to be ‘stopwatch’; text information regarding or associated with the object 3 230 is ‘timer’ because the object 3 230 is displayed to be ‘timer’; text information regarding or associated with the object 4 240 is ‘additional alarm setting’ because the object 4 240 is displayed to be ‘additional alarm setting’; and text information regarding or associated with the object 5 250 is ‘alarm’ because the object 5 250 is displayed to be ‘alarm.’ In FIG. 2, as the object searching unit 130 locates the object 1 210, the object 2 220, the object 3 230, the object 4 240 and the object 5 250, the text information obtaining unit 141 may obtain or retrieve text information or text command information ‘world time’, ‘stopwatch’, ‘timer’, ‘additional alarm setting’, and ‘alarm’ from the objects 210 to 250, respectively.

The comparing unit 142 may detect text information that is identical or similar to voice command information, by comparing the text information or text command information obtained by the text information obtaining unit 141 and voice command information obtained by the voice recognizing unit 120. Here, the text information similar to voice command information is text information that is identical to a part or portion of the voice command information. That is, if voice command information ‘execute confirmation’ is obtained, text information ‘confirmation’ is identical to a part of the voice command information, and thus the text information is similar to the voice command information.

In FIG. 2, if a voice saying ‘stopwatch’ (or ‘execute stopwatch’) is received, for example, from a user, through the voice receiving unit 110, the voice recognizing unit 120 obtain is voice command information ‘stopwatch’ (or, ‘execute stopwatch’) by analyzing the received voice. Then, the comparing unit 142 compares the text command information obtained by the text information obtaining unit 141 (for example, ‘world time’, ‘stopwatch’, ‘timer’, ‘additional alarm setting’ and ‘alarm’) with the voice command information obtained by the voice recognizing unit 120 (for example, ‘stopwatch’, ‘execute stopwatch’). As a result, the comparing unit 142 may detect that the ‘stopwatch’ text information is identical or similar to the voice command information.

The object executing unit 143 may execute an object corresponding to the text information detected by the comparing unit 142. In the above-described example, the object executing unit 143 may execute the object 2 220 corresponding to ‘stopwatch’ detected by the comparing unit 142. In addition, if there is no text information obtained by the text information obtaining unit 141, for example, if voice command information input by a user is not identical to the text information, text information most similar to the voice information may be executed or text information may not be executed.

In some embodiments, the apparatus 100 may include a User Interface (UI) generating unit 150. The UI generating unit 150 generates a UI to display objects found by the object searching unit 130. Here, the UI may provide a list of objects found by the object searching unit 130.

The apparatus 100 may include a state converting unit 170. The state converting unit 170 may activate or deactivate a voice recognition function according to whether a voice is received from the user or whether a predetermined activation command is received from the user. The state converting unit 170 may deactivate an activated voice recognition function if a voice is not received from a user for a predetermined length of time, and may activate a is deactivated voice recognition function if an activation command is received from a user. The activation command may occur when the user clicks a specific key provided in the apparatus 100 or inputs a specific voice command, for example, ‘Hi, Vega’. The above-described operation is not necessarily required, and may be performed even when the application being executed in a foreground supports the voice recognition processing function.

In some embodiments, the apparatus 100 may include an application determining unit 160. The application determining unit 160 determines whether an application being executed in a foreground supports a voice recognition processing function. If the application determining unit 160 determines that the application being executed in a foreground does not support a voice recognition processing function, the object searching unit 130 may search for an executable object in the application. That is, if the application being executed in a foreground supports a voice recognition processing function, the object searching unit 130 does not operate. However, according to system performance or a purpose of use, the object searching unit 130 may operate even when an application being executed in a foreground supports a voice recognition processing function.

In a case when the application being executed in a foreground supports the voice recognition processing function, the apparatus 100 may include a command delivering unit 180 to deliver voice command information obtained by the voice recognizing unit 110 to the application.

In some embodiments, the apparatus 100 may include a storage unit 190. The storage unit 190 extracts and stores a text list of objects for displaying in phases of execution of an application.

FIG. 3 is a diagram illustrating an example of a UI generated by a UI generating is unit illustrated in FIG. 1.

Referring to FIG. 3, the UI provides a list 310 of objects found by the object searching unit 130.

A user may input a voice with reference to the UI generated by the UI generating unit 150.

The UI generated by the UI generating unit 150 may be displayed for a predetermined length of time, and disappear after the predetermined length of time. In addition, the UI may not be displayed on the screen when a voice recognition function is deactivated, and may be displayed when the voice recognition function is activated in response to a user's activation command.

FIG. 4 is a flow chart illustrating a method for executing an object using a voice command according to exemplary embodiments of the present invention.

Referring to FIG. 4, in the method for executing an object using a voice command, whether an application being executed supports a voice recognition processing function is determined in operation 405. The application can be executed in the foreground. If it is determined in operation 405 that the application being executed in a foreground does not support a voice recognition processing function (the “NO” branch from 405), a search for an executable object is performed in the application being executed in a foreground in operation 410. In the embodiment of FIG. 2, the objects 1 210, the object 2 220, the object 3 230, the object 4 240 and the object 5 250 may be found by the search. Operation 405 may be omitted according to a purpose of use or system performance.

Then, text information is obtained from each of the found objects in operation 415. In the embodiment in FIG. 2, text information ‘world time’, ‘stopwatch’, ‘timer’, is ‘additional alarm setting’ and ‘alarm’ may be obtained from the objects 1 210, the object 2 220, the object 3 230, the object 4 240 and the object 5 250, respectively.

Then, a UI is generated and displayed on a screen to display the found objects in operation 420. For example, the generated UI may provide a list of objects. In some embodiments, each of the objects may be displayed in the UI using the text information obtained in operation 415.

Then, whether a voice is received from a user for an interval or a predetermined length of time is determined in operation 425. It is determined in operation 425 that a voice is received from a user within an interval, voice command information is obtained by recognizing and analyzing the received voice in operation 430.

Then, operation 435 determines whether there is text information identical or similar to the voice command information by comparing the text information associated with or regarding each of the found objects obtained in operation 415 with the voice command information obtained in operation 430. If it is determined in operation 435 that there is text information identical or similar to the voice command information (the “YES” branch from 435), an object corresponding to the identical or similar text information is executed in operation 440. For example, suppose that a user inputs a voice saying ‘stopwatch’ or ‘execute a stopwatch’, and thus voice command information ‘stopwatch’ or ‘execute a stopwatch’ is obtained in operation 430, and obtained text information is ‘world time’, ‘stopwatch’, ‘timer’, ‘additional alarm setting’ and ‘alarm’ in operation 425. When the text information ‘stopwatch’ is identical or similar) to the voice command information ‘stopwatch’ or, ‘execute a stopwatch’, the object 2 220 corresponding to ‘stopwatch’ is executed.

When it is determined in operation 435 that there is no text information identical is or similar to the voice command information (the “NO” branch from 435, the process returns to operation 425 to receive a voice from the user again.

When it is determined in operation 425 that any voice is not received from the user for an interval or a predetermined length of time (the “NO” branch from 425), a voice recognition function is deactivated until an activation command is received in operation 445. The activation command may occur when the user clicks a specific key or inputs a specific voice command (for example, ‘Hi, Vega’), but aspects of the present invention are not limited thereto.

When it is determined in operation 405 (the “YES” branch from 405) that the application being executed in a foreground supports a voice recognition processing function, whether a voice is received from the user for an interval or a predetermined length of time is determined in operation 450. If it is determined in operation 450 that a voice is received from the user within an interval a predetermined length of time (the “YES” branch from 450), voice command information is obtained by recognizing and analyzing the received voice in operation 455, and then the obtained voice command information is delivered to the application being executed in a foreground in operation 460. Accordingly, the application executes a command in accordance with received voice command information.

When it is determined in operation 450 that any voice is not received from the user for a predetermined length of time (the “NO” branch from 450), a voice recognition function is deactivated until an activation command is received in operation 445.

FIG. 5 is a diagram illustrating a configuration of an apparatus for executing an object using a voice command according to exemplary embodiments of the present invention.

Referring to FIG. 5, an apparatus 500 for executing an object using a voice command may include a voice receiving unit 510, a voice recognizing unit 520, an object is searching unit 530, an object driving unit 540, a UI generating unit 550, an application determining unit 560, a state converting unit 570, a command delivering unit 580 and a storage unit 590. The apparatus 500 has the same configurations as those of the apparatus 100 in FIG. 1, as well as configurations described in following. Thus, detailed description about the configurations described above with reference to FIG. 1 will not be provided. In addition, the apparatus 500 may be realized in various forms, including the apparatus 100 in FIG. 1.

The object driving unit 540 may include an execution command assigning unit 541, a comparing unit 542 and an object executing unit 543.

The execution command assigning unit 541 may assign an arbitrary execution command to each object found by the object searching unit 530. For example, if the objects 1 210, the object 2 220, the object 3 230, the object 4 240 and the object 5 250 of FIG. 2 are found, the execution command assigning unit 541 may assign an execution command ‘1’ to the object 1 210, an execution command ‘2’ to the object 2 220, an execution command ‘3’ to the object 3 230, an execution command ‘4’ to the object 4 240, and an execution command ‘5’ to the object 5 250.

Meanwhile, the UI generating unit 550 may generate a UI with reference to execution commands assigned by the execution command assigning unit 541.

The comparing unit 542 may detect an execution command identical or similar to the voice command information by comparing the execution command assigned by the execution command assigning unit 541 and the voice command information obtained by the voice recognizing unit 520.

In then example, if a voice saying ‘1’ or ‘execute 1’ is received from a user in the voice receiving unit 110, the voice recognizing unit 120 may obtain the voice command is information ‘1’ or, ‘execute 1’ by analyzing the user's voice. Then, the comparing unit 142 may compare the execution commands ‘1’, ‘2’, ‘3’, ‘4’, and ‘5’ with the voice command information ‘1’, and then detect that the execution command ‘1’ is identical or similar to the voice command information.

The object executing unit 543 executes an object corresponding to the execution command detected by the comparing unit 542. In the above-described example, the object executing unit 543 may execute the object 1 210 corresponding to the execution command ‘1’ detected by the comparing unit 542.

FIG. 6 is a diagram illustrating an example of a UI generated by a UI generating unit illustrated in FIG. 5.

Referring to FIG. 6, a UI may provide a list 610 of objects found by the object searching unit 530 and a list 620 of execution commands assigned to or corresponding to objects by the execution command assigning unit 541. That is, the UI generating unit 550 may generate a UI that provides a list 610 of objects and a list 620 of execution commands together.

In some embodiments, a user is able to input a voice with reference to the UI generated by the UI generating unit 550.

A UI generated by the UI generating unit 550 may be displayed for an interval or a predetermined length of time, and disappear after the interval or predetermined length of time. In addition, the UI may not displayed when a voice recognition function is deactivated, and then may be displayed when the voice recognition function is activated in response to a user's activation command.

FIG. 7 is a flow chart illustrating a method for executing an object using a voice command according to exemplary embodiments of the present invention.

Referring to FIG. 7, in a method for executing an object using a voice command according to exemplary embodiments of the present invention, whether an application being executed supports a voice recognition processing function is determined in operation 705. The application can be executed in the foreground. If it is determined in operation 705 that the application does not support a voice recognition processing function, a search for an executable object is performed in the application in operation 710. Meanwhile, operation 705 may be omitted according to a purpose of use or system performance.

Then, an arbitrary execution command is assigned to each of the found objects in operation 715.

Then, a UI is displayed on a screen to display the found objects in operation 720. The UI may provide a list of found objects and a list of execution commands assigned to the found objects, respectively.

Then, whether a voice is received from the user for an interval or a predetermined length of time is determined in operation 725. If it is determined in operation 725 that a voice is received from a user within an interval or a predetermined length of time, voice command information is obtained by recognizing and analyzing the received voice in operation 730.

Then, whether there is execution command identical or similar to the voice command information is determined by comparing the assigned execution commands with the voice command information in operation 735. If it is determined in operation 735 that there is execution command identical or similar to the voice command information, an object corresponding to the identical or similar execution command is executed in operation 740.

When it is determined in operation 735 that there is no execution command identical or similar to the voice command information, the process returns to operation 725 to again receive a voice from the user.

When it is determined in operation 725 that a voice is not received from the user within the interval or predetermined length of time, the voice recognition function is deactivated until an activation command is received in operation 745.

When it is determined in operation 705 that the application being executed in a foreground supports the voice recognition processing function, whether a voice is received from the user within an interval or a predetermined length of time is determined in operation 750. If it is determined in operation 750 that a voice is received from the user within an interval or a predetermined length of time, voice command information is obtained by recognizing and analyzing the received voice in operation 755, and then the voice command information is delivered to the application being executed in a foreground in operation 760. Accordingly, the application executes a command in accordance with the received voice command information.

When it is determined in operation 750 that any voice is not received from the user for a predetermined length of time, the voice recognition function is deactivated until an activation command is received in operation 745.

FIG. 8 is a diagram illustrating a configuration of an apparatus for executing an object using a voice command according to exemplary embodiments of the present invention.

Referring to FIG. 8, an apparatus 800 for executing an object using a voice command includes a voice receiving unit 810, a voice recognizing unit 820, an object searching unit 830, an object driving unit 840, a UI generating unit 850, an application determining unit 860, a state converting unit 870, a command delivering unit 880 and a storage unit 890. Here, the apparatus 800 includes the same configurations as those of the apparatus 100 in FIG. 1, as well as configurations described in following. Thus, detailed descriptions about the is configurations described above with reference to FIG. 1 will not be provided. In addition, the apparatus 800 may be realized in various forms, including the apparatus 100 in FIG. 1.

The object driving unit 840 includes a focus shifting unit 841 and an object executing unit 842.

The focus shifting unit 841 determines whether voice command information obtained by the voice recognizing unit 820 is a predetermined focus shift command, and, if so, shifts a focus to select one of objects found by the object searching unit 830. For example, the focus shift command may be ‘up’ for shifting a focus upward, ‘down’ for shifting a focus downward, ‘left’ for shifting a focus to the left side and ‘right’ for shifting a focus to a right side. This is merely an example, and various focus shift commands may be set.

If the voice command information obtained by the voice recognizing unit 820 is a predetermined object execution command, the object executing unit 842 executes an object that has the focus at a time when a voice is received. For example, objects 1 to 5 are found by the object searching unit 830 and a user wishes to execute the object 3. In this case, the user inputs a focus shift command to focus on the object 3. When the focus has been located to the object 3, usually conveyed by a visual effect highlighting the focused upon object, the user may input an object execution command. Upon receiving the object execution command, the object executing unit 842 executes the object 3 that is focused at a time when the voice is received.

The UI generating unit 850 may generate a UI to display the objects found by the object searching unit 830. The UI may provide, for example, a list of objects, a list of executable commands, and an indicator (like an arrow key indicating directions) toward one or more objects to which a focus is able to be shifted.

FIG. 9 is a diagram illustrating an example of a UI generated by the UI is generating unit illustrated in FIG. 8.

Referring to FIG. 9, a UI provides a list 910 of objects found by the object searching unit 830, a list 921 of executable commands, an arrow key indicating a direction toward which a focus is able to be shifted, and a focus 930. In this case, the list 921 of executable commands and an arrow key 922 are displayed in a dashboard 920.

A user is able to input a voice with reference to the UI generated by the UI generating unit 850.

The UI may be displayed on a screen for an interval or a predetermined length of time, and disappear after the interval or predetermined length of time. The UI displayed on the screen due to a deactivated voice recognition function may be displayed or re-displayed when the voice recognition function is activated in response to a user's activation command.

FIG. 10 is a flow chart illustrating a method for executing an object using a voice command according to exemplary embodiments of the present invention.

Referring to FIG. 10, in the method for executing an object using a voice command, whether an application being executed supports a voice recognition processing function is determined in operation 1005. The application can be executed in the foreground. If it is determined in operation 1005 that the application supports the voice recognition processing function, a search for an executable object is performed in the application in operation 1010. Operation 1005 may be omitted according to a purpose of use or system performance.

Then, a UI is generated and displayed on a screen to display objects found in operation 1015. The UI may provide, for example, a list of found objects, a list of executable commands, an arrow key indicating directions toward which a focus may be shifted, and the focus. The list of executable commands and the arrow key may be displayed in a dash board, but is aspects of the present invention are not limited thereto.

Then, operation 1020 determines whether a voice is received from a user within an interval or a predetermined length of time. If it is determined in operation 1020 that a voice is received from a user within the interval or predetermined length of time, voice command information is obtained by recognizing and analyzing the received voice in operation 1025.

Then, operation 1030 determines whether the voice command information is a predetermined focus shift command. If operation 1030 determines that the voice command information is not a predetermined focus shift command, operation 1035 determines whether the voice command information is a predetermined object execution command. If it is determined in operation 1035 that the voice command information is a predetermined object execution command, an object that has the focus at a time when the voice is received, is executed in operation 1040.

When it is determined in operation 1035 that the voice command information is not the predetermined object execution command, the process returns to operation 1020.

When it is determined in operation 1030 that the voice command information is the predetermined focus shift command, the focus is shifted in accordance with the corresponding focus shift command to select one of the found objects in operation 1065.

When it is determined in operation 1020 that a voice is not received from the user within the interval or predetermined length of time, the voice recognition function is deactivated until an activation command is received per operation 1045.

When it is determined in operation 1005 that the application being executed in a foreground supports the voice recognition processing function, whether a voice is received from the user within an interval or a predetermined length of time is determined in 1050. If it is is determined in operation 1050 that a voice is received from the user within the interval or predetermined length of time, voice command information is obtained by recognizing and analyzing the received command in operation 1055, and then the obtained voice command information is delivered to the application. Accordingly, the application executes a command in accordance with the received voice command information.

When it is determined in operation 1050 that a voice is not received from the user for the predetermined length of time, the voice recognition function is deactivated until an activation command is received in operation 1045.

It is possible to apply voice recognition in an application not designed to support voice recognition by extracting an object from the application and executing the object based on information obtained through voice recognition.

In addition, even an application supporting voice recognition does not necessarily include a Software Development Kit (SDK) and the teachings herein may enhance effectiveness in developing for such an application.

Furthermore, when using an application not supporting voice recognition, a user is able to intuitively recognize an executable object in an application, enhancing the user's convenience.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the is computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method, utilizing a processor, for executing an object using a voice command, the method comprising:
searching for an executable object in an application; and
associating a text command information with the executable object.

2. The method of claim 1, further comprising:
receiving a voice;
recognizing the voice to obtain a voice command; and
executing the executable object when the voice command is similar to the text command information associated with the executable object.

3. The method of claim 2, further comprising deactivating the receiving the voice until an activation command is received or when the voice command is not received within an interval.

4. The method of claim 2, wherein the application as programmed does not provide voice recognition.

5. The method of claim 1, wherein the associating comprises obtaining the text command information from the executable object.

6. The method of claim 1, wherein the associating comprises assigning the text command information to the executable object.

7. The method of claim 1, further comprising generating and displaying a user interface indicating the executable object.

8. The method of claim 1, further comprising shifting a focus to the executable object using a voiced focus shift command.

9. The method of claim 1, further comprising extracting and storing a text list of objects for displaying in a plurality of phases of execution of the application.

10. A terminal to execute an object using a voice command, the terminal comprising:
a searching unit configured to search for an executable object in an application; and
a text information obtaining unit configured to associate a text command information with the executable object.

11. The terminal of claim 10, further comprising:
a voice receiving unit configured to receive a voice;
a voice recognizing unit configured to recognize the voice to obtain a voice command;
a comparing unit configured to compare the voice command to the text command information; and
an object executing unit configured to execute the executable object, when the comparing unit determines that the voice command is similar to the text command information associated with the executable object.

12. The terminal of claim 11, further comprising a state converting unit configured to deactivate the voice receiving unit until an activation command is received or when the voice is not received within an interval.

13. The method of claim 11, wherein the application as programmed does not provide voice recognition.

14. The terminal of claim 10, wherein the text information obtaining unit is configured to obtain the text command information from the executable object.

15. The terminal of claim 10, wherein the text information obtaining unit is configured to assign the text command information to the executable object.

16. The terminal of claim 10, further comprising a user interface generating unit configured to generate and display a user interface indicating the executable object.

17. The terminal of claim 10, further comprising a focus shifting unit configured to shift a focus to the executable object using a voiced focus shift command.

18. The terminal of claim 10, further comprising a storage unit configured to store and a text list of objects extracted for displaying in a plurality of phases of execution of the application.
